(19) United States
(12) Patent Application Publication
(10) Pub. No.: US 2024/0406050 A1
(43) Pub. Date: Dec. 5, 2024

(54) SYSTEM AND METHOD FOR CARRIER FREQUENCY OFFSET ESTIMATION

(71) Applicant: Huawei Technologies Co., Ltd., Shenzhen (CN)

(72) Inventors: Ahmad Mustafa Musa Abu Al Haija, Ottawa (CA); Mohammadhadi Baligh, Ottawa (CA)

(21) Appl. No.: 18/802,813

(22) Filed: Aug. 13, 2024

Related U.S. Application Data
(63) Continuation of application No. PCT/CN2022/076211, filed on Feb. 14, 2022.

(51) Int. Cl. H04L 27/26; H04L 5/00

(52) U.S. Cl. CPC H04L 27/2675; H04L 5/0007; H04L 27/2659; H04L 27/266

(57) ABSTRACT

The application provides a system and method for CFO estimation based on two (or more) sequences that are separate in time. Each sequence consists of two combined sequences. A combination of coarse estimation followed by fine estimation is used. Options are provided to include the transmission of the two sequences within a structure consistent with previous SSB block formats for one or both initial and non-initial access processes.

### CROSS REFERENCE

The application is a continuation of International Application No. PCT/CN2022/076211, filed on Feb. 14, 2022, the disclosure of which is hereby incorporated by reference in its entirety.

### TECHNICAL FIELD

The application relates to wireless communications generally, and more specifically to carrier frequency offset (CFO) estimation for initial access, for example at high frequencies, such as for sub-THz frequency communications.

### BACKGROUND

Recently, high frequency and sub-THz communications have been receiving heightened research interest as a key enabler for future wireless networks. However, as the frequency range increases, there is an increased need for frequency synchronization, due to increased Doppler shift, increased CFO, and increased phase noise. Hence, it is important to improve CFO estimation to facilitate high frequency communication.

Currently, in 5G New Radio (NR), during an initial access process, the synchronization procedure is based on the beam management operations. In these operations, the base station (BS) or gNB, via beam sweeping, periodically transmits synchronization signal (SS) burst that carries multiple SS blocks (SSBs) where each SSB is transmitted via a specific beam with pre-specified interval and direction. By using one or more of the primary synchronization signal (PSS), secondary synchronization signal (SSS), and physical broadcast channel (PBCH) with some synchronization algorithms, the UE can estimate and correct the frequency and time offsets. However, with the increase of the subcarrier spacing (SCS) of orthogonal frequency division multiplexing (OFDM) at high frequency, the OFDM symbol duration reduces, which in turn reduces the accuracy of the CFO estimation.

### SUMMARY

The application provides a system and method for CFO estimation based on two (or more) sequences that are separate in time. Each sequence consists of two combined sequences. A combination of coarse estimation followed by fine estimation is used. Options are provided to include the transmission of the two sequences within a structure consistent with previous SSB block formats for one or both initial and non-initial access processes.

An initial access process may, for example, refer to cases when a user equipment (UE) cannot be provided with assistance information, while a non-initial access process may, for example, refer to cases when a UE can be provided with assistance information. The assistance information in this context is the information that can help the UE access the network. Examples of such information include (but not limited to) 1) the raster or carrier frequency and or the SCS that is used for the burst transmission of SSBs, 2) the candidate beam directions (with respect to a specific direction (e.g. north direction) at the UE that may receive the SSB with higher probability (these directions can be estimated by the BS or network considering some sensing information (e.g. UE location)).

According to one aspect of the present disclosure, there is provided a method comprising: obtaining a first combined synchronization sequence based on a base sequence and a first cover code; obtaining a second combined synchronization sequence based on the base sequence with a second cover code; transmitting the first combined synchronization sequence as part of a first OFDM symbol and transmitting the second combined synchronization sequence as part of a second OFDM symbol.

In some embodiments, obtaining a first combined synchronization sequence based on a base sequence and a first cover code comprising: combining a base sequence with the first cover code to produce the first combined synchronization sequence.

In some embodiments, obtaining a second combined synchronization sequence based on the base sequence with a second cover code to produce comprising: combining a base sequence with the second cover code to produce the second combined synchronization sequence.

In some embodiments, the base sequence is one of: a primary synchronization sequence; a secondary synchronization sequence.

In some embodiments, transmitting the first combined synchronization sequence as part of a first OFDM symbol and transmitting the second combined synchronization sequence as part of a second OFDM symbol comprises: transmitting a four OFDM symbol synchronization sequence block (SSB), wherein one of the four symbols is said first OFDM symbol; transmitting a fifth OFDM symbol that is said second OFDM symbol.

In some embodiments, transmitting the first combined synchronization sequence as part of a first OFDM symbol and transmitting the second combined synchronization sequence as part of a second OFDM symbol comprises: transmitting a four OFDM symbol synchronization sequence block (SSB), wherein one of the four symbols is said first OFDM symbol, and another of said four symbols is said second OFDM symbol.

In some embodiments, the one of the four symbols is a first of the four OFDM symbols, the first of the four symbols also containing physical broadcast channel (PBCH) information.

In some embodiments, the base sequence is a primary synchronization sequence or a secondary synchronization sequence of a synchronization sequence block

In some embodiments, combining the base sequence with the first cover code to produce the first combined synchronization sequence, and combining the base sequence with the second cover code to produce the second combined synchronization sequence are performed using circular convolution in the frequency domain or using multiplication in the time domain.

In some embodiments, the method further comprises: transmitting signalling to indicate the cover codes being used.

According to another aspect of the present disclosure, there is provided network element comprising: obtaining a first combined synchronization sequence based on a base sequence and a first cover code; obtaining a second combined synchronization sequence based on the base sequence with a second cover code; transmitting the first combined synchronization sequence as part of a first OFDM symbol and transmitting the second combined synchronization sequence as part of a second OFDM symbol.

In some embodiments, obtaining a first combined synchronization sequence based on a base sequence and a first cover code comprising: combining a base sequence with the first cover code to produce the first combined synchronization sequence.

In some embodiments, obtaining a second combined synchronization sequence based on the base sequence with a second cover code to produce comprising: combining a base sequence with the second cover code to produce the second combined synchronization sequence.

In some embodiments, the base sequence is one of: a primary synchronization sequence; a secondary synchronization sequence.

In some embodiments, transmitting the first combined synchronization sequence as part of a first OFDM symbol and transmitting the second combined synchronization sequence as part of a second OFDM symbol comprises: transmitting a four OFDM symbol synchronization sequence block (SSB), wherein one of the four symbols is said first OFDM symbol; transmitting a fifth OFDM symbol that is said second OFDM symbol.

In some embodiments, transmitting the first combined synchronization sequence as part of a first OFDM symbol and transmitting the second combined synchronization sequence as part of a second OFDM symbol comprises: transmitting a four OFDM symbol synchronization sequence block (SSB), wherein one of the four symbols is said first OFDM symbol, and another of said four symbols is said second OFDM symbol.

In some embodiments, the one of the four symbols is a first of the four OFDM symbols, the first of the four symbols also containing physical broadcast channel (PBCH) information.

In some embodiments, the base sequence is a primary synchronization sequence or a secondary synchronization sequence of a synchronization sequence block

In some embodiments, combining the base sequence with the first cover code to produce the first combined synchronization sequence, and combining the base sequence with the second cover code to produce the second combined synchronization sequence are performed using circular convolution in the frequency domain or using multiplication in the time domain.

In some embodiments, the network element further comprises: transmitting signalling to indicate the cover codes being used.

According to another aspect of the present disclosure, there is provided a method comprising: receiving a signal containing a first combined synchronization sequence (CSS) in a first OFDM symbol and a second CSS in a second OFDM symbol, wherein the first CSS is formed by a base sequence and a first cover code, and the second CSS is formed by the base sequence and a second cover code; obtaining a first CFO estimate obtained as a function of one of or both of the first CSS and the second CSS; obtaining a second CFO estimate based on the first CSS and the second CSS, using the coarse CFO estimate to select between multiple possible values for the fine CFO estimate, wherein the second CFO estimate is more precise than the first CFO estimate; compensating for the CFO and detecting further information

In some embodiments, obtaining a coarse estimate is based on a ratio of amplitude square of received samples for each of the first and second CSS.

In some embodiments, obtaining a fine CFO estimate comprises: estimating a phase difference between a sample of the first CSS and a sample of the second CSS; obtaining the fine CFO estimate from the estimated phase difference.

According to another aspect of the present disclosure, there is provided an apparatus comprising: a processor and a memory, the apparatus configured to perform a method for receiving downlink control information (DCI), the method comprising: receiving a signal containing a first combined synchronization sequence (CSS) in a first OFDM symbol and a second CSS in a second OFDM symbol, wherein the first CSS is formed by a base sequence and a first cover code, and the second CSS is formed by the base sequence and a second cover code; obtaining a first CFO estimate obtained as a function of one of or both of the first CSS and the second CSS; obtaining a second CFO estimate based on the first CSS and the second CSS, using the coarse CFO estimate to select between multiple possible values for the fine CFO estimate, wherein the second CFO estimate is more precise than the first CFO estimate; compensating for the CFO and detecting further information

In some embodiments, obtaining a coarse estimate is based on a ratio of amplitude square of received samples for each of the first and second CSS.

In some embodiments, obtaining a fine CFO estimate comprises: estimating a phase difference between of the first received CSS and the second received CSS; obtaining the fine CFO estimate from the estimated phase difference.

### BRIEF DESCRIPTION OF THE DRAWINGS

Embodiments of the disclosure will now be described with reference to the attached drawings in which:

FIG. 1 is a block diagram of a communication system;

FIG. 2 is a block diagram of a communication system;

FIG. 3 is a block diagram of a communication system showing a basic component structure of an electronic device (ED) and a base station;

FIG. 4 is a block diagram of modules that may be used to implement or perform one or more of the steps of embodiments of the application;

FIG. 5A, shown is a block diagram of a method of generating and transmitting two sequences for use in CFO estimation;

FIG. 5B is a flowchart of a method of CFO estimation;

FIGS. 6A to 6C show three examples of how two sequences for CFO estimation can be transmitted within an SSB structure; and

FIG. 7 is a plot of phase difference between corresponding samples as a function of normalized CFO.

### DETAILED DESCRIPTION

The operation of the current example embodiments and the structure thereof are discussed in detail below. It should be appreciated, however, that the present disclosure provides many applicable inventive concepts that can be embodied in any of a wide variety of specific contexts. The specific embodiments discussed are merely illustrative of specific structures of the disclosure and ways to operate the disclosure, and do not limit the scope of the present disclosure.

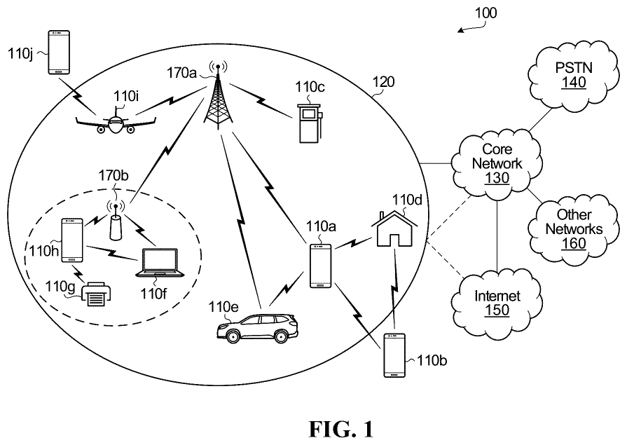

Referring to FIG. 1, as an illustrative example without limitation, a simplified schematic illustration of a communication system is provided. The communication system 100 comprises a radio access network 120. The radio access network 120 may be a next generation (e.g. sixth generation (6G) or later) radio access network, or a legacy (e.g. 5G, 4G, 3G or 2G) radio access network. One or more communication electric device (ED) 110a-110j (generically referred to as 110) may be interconnected to one another or connected to one or more network nodes (170a, 170b, generically referred to as 170) in the radio access network 120. A core network 130 may be a part of the communication system and may be dependent or independent of the radio access technology used in the communication system 100. Also the communication system 100 comprises a public switched telephone network (PSTN) 140, the internet 150, and other networks 160.

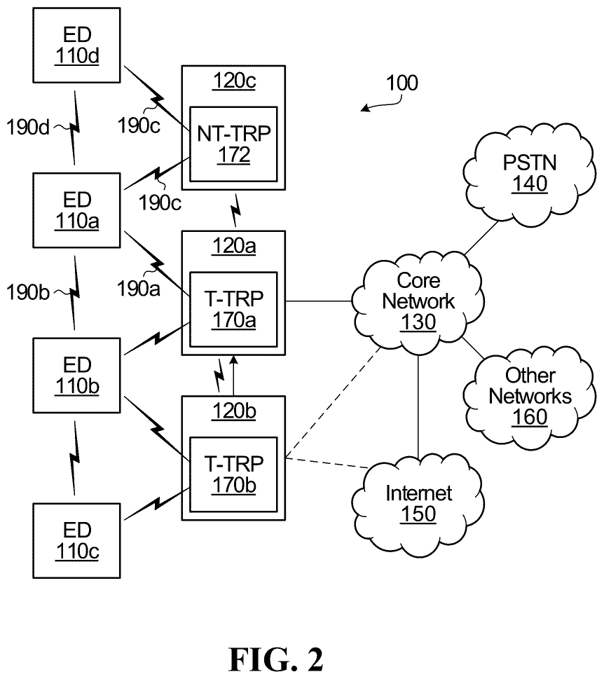

FIG. 2 illustrates an example communication system 100. In general, the communication system 100 enables multiple wireless or wired elements to communicate data and other content. The purpose of the communication system 100 may be to provide content, such as voice, data, video, and/or text, via broadcast, multicast and unicast, etc. The communication system 100 may operate by sharing resources, such as carrier spectrum bandwidth, between its constituent elements. The communication system 100 may include a terrestrial communication system and/or a non-terrestrial communication system. The communication system 100 may provide a wide range of communication services and applications (such as earth monitoring, remote sensing, passive sensing and positioning, navigation and tracking, autonomous delivery and mobility, etc.). The communication system 100 may provide a high degree of availability and robustness through a joint operation of the terrestrial communication system and the non-terrestrial communication system. For example, integrating a non-terrestrial communication system (or components thereof) into a terrestrial communication system can result in what may be considered a heterogeneous network comprising multiple layers. Compared to conventional communication networks, the heterogeneous network may achieve better overall performance through efficient multi-link joint operation, more flexible functionality sharing, and faster physical layer link switching between terrestrial networks and non-terrestrial networks.

The terrestrial communication system and the non-terrestrial communication system could be considered sub-systems of the communication system. In the example shown, the communication system 100 includes electronic devices (ED) 110a-110d (generically referred to as ED 110), radio access networks (RANs) 120a-120b, non-terrestrial communication network 120c, a core network 130, a public switched telephone network (PSTN) 140, the internet 150, and other networks 160. The RANs 120a-120b include respective base stations (BSs) 170a-170b, which may be generically referred to as terrestrial transmit and receive points (T-TRPs) 170a-170b. The non-terrestrial communication network 120c includes an access node 120c, which may be generically referred to as a non-terrestrial transmit and receive point (NT-TRP) 172.

Any ED 110 may be alternatively or additionally configured to interface, access, or communicate with any other T-TRP 170a-170b and NT-TRP 172, the internet 150, the core network 130, the PSTN 140, the other networks 160, or any combination of the preceding. In some examples, ED 110a may communicate an uplink and/or downlink transmission over an interface 190a with T-TRP 170a. In some examples, the EDs 110a, 110b and 110d may also communicate directly with one another via one or more sidelink air interfaces 190b. In some examples, ED 110d may communicate an uplink and/or downlink transmission over an interface 190c with NT-TRP 172.

The air interfaces 190a and 190b may use similar communication technology, such as any suitable radio access technology. For example, the communication system 100 may implement one or more channel access methods, such as code division multiple access (CDMA), time division multiple access (TDMA), frequency division multiple access (FDMA), orthogonal FDMA (OFDMA), or single-carrier FDMA (SC-FDMA) in the air interfaces 190a and 190b. The air interfaces 190a and 190b may utilize other higher dimension signal spaces, which may involve a combination of orthogonal and/or non-orthogonal dimensions.

The air interface 190c can enable communication between the ED 110d and one or multiple NT-TRPs 172 via a wireless link or simply a link. For some examples, the link is a dedicated connection for unicast transmission, a connection for broadcast transmission, or a connection between a group of EDs and one or multiple NT-TRPs for multicast transmission.

The RANs 120a and 120b are in communication with the core network 130 to provide the EDs 110a 110b, and 110c with various services such as voice, data, and other services. The RANs 120a and 120b and/or the core network 130 may be in direct or indirect communication with one or more other RANs (not shown), which may or may not be directly served by core network 130, and may or may not employ the same radio access technology as RAN 120a, RAN 120b or both. The core network 130 may also serve as a gateway access between (i) the RANs 120a and 120b or EDs 110a 110b, and 110c or both, and (ii) other networks (such as the PSTN 140, the internet 150, and the other networks 160). In addition, some or all of the EDs 110a 110b, and 110c may include functionality for communicating with different wireless networks over different wireless links using different wireless technologies and/or protocols. Instead of wireless communication (or in addition thereto), the EDs 110a 110b, and 110c may communicate via wired communication channels to a service provider or switch (not shown), and to the internet 150. PSTN 140 may include circuit switched telephone networks for providing plain old telephone service (POTS). Internet 150 may include a network of computers and subnets (intranets) or both, and incorporate protocols, such as Internet Protocol (IP), Transmission Control Protocol (TCP), User Datagram Protocol (UDP). EDs 110a 110b, and 110c may be multimode devices capable of operation according to multiple radio access technologies, and incorporate multiple transceivers necessary to support such.

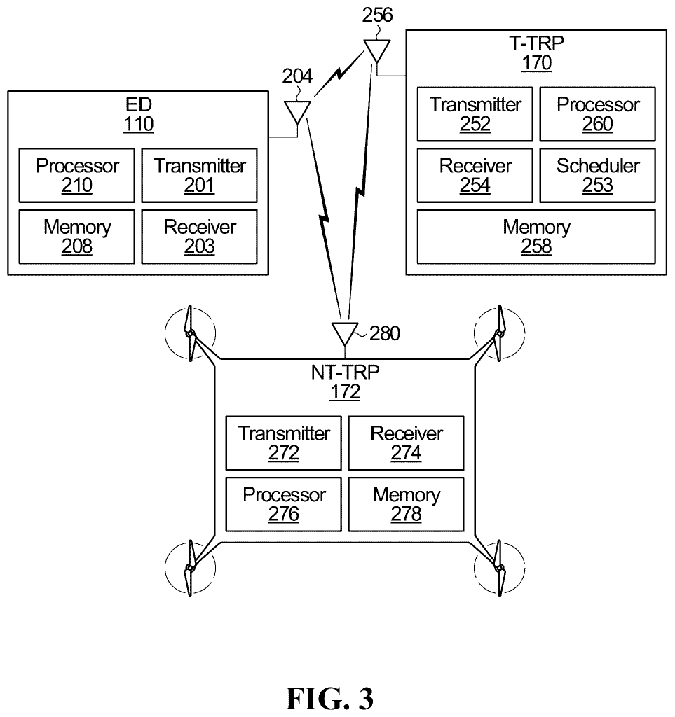

FIG. 3 illustrates another example of an ED 110 and a base station 170a, 170b and/or 170c. The ED 110 is used to connect persons, objects, machines, etc. The ED 110 may be widely used in various scenarios, for example, cellular communications, device-to-device (D2D), vehicle to everything (V2X), peer-to-peer (P2P), machine-to-machine (M2M), machine-type communications (MTC), internet of things (IoT), virtual reality (VR), augmented reality (AR), industrial control, self-driving, remote medical, smart grid, smart furniture, smart office, smart wearable, smart transportation, smart city, drones, robots, remote sensing, passive sensing, positioning, navigation and tracking, autonomous delivery and mobility, etc.

Each ED 110 represents any suitable end user device for wireless operation and may include such devices (or may be referred to) as a user equipment/device (UE), a wireless transmit/receive unit (WTRU), a mobile station, a fixed or mobile subscriber unit, a cellular telephone, a station (STA), a machine type communication (MTC) device, a personal digital assistant (PDA), a smartphone, a laptop, a computer, a tablet, a wireless sensor, a consumer electronics device, a smart book, a vehicle, a car, a truck, a bus, a train, or an IoT device, an industrial device, or apparatus (e.g. communication module, modem, or chip) in the forgoing devices, among other possibilities. Future generation EDs 110 may be referred to using other terms. The base station 170a and 170b is a T-TRP and will hereafter be referred to as T-TRP 170. Also shown in FIG. 3, a NT-TRP will hereafter be referred to as NT-TRP 172. Each ED 110 connected to T-TRP 170 and/or NT-TRP 172 can be dynamically or semi-statically turned-on (i.e., established, activated, or enabled), turned-off (i.e., released, deactivated, or disabled) and/or configured in response to one of more of: connection availability and connection necessity.

The ED 110 includes a transmitter 201 and a receiver 203 coupled to one or more antennas 204. Only one antenna 204 is illustrated. One, some, or all of the antennas may alternatively be panels. The transmitter 201 and the receiver 203 may be integrated, e.g. as a transceiver. The transceiver is configured to modulate data or other content for transmission by at least one antenna 204 or network interface controller (NIC). The transceiver is also configured to demodulate data or other content received by the at least one antenna 204. Each transceiver includes any suitable structure for generating signals for wireless or wired transmission and/or processing signals received wirelessly or by wire. Each antenna 204 includes any suitable structure for transmitting and/or receiving wireless or wired signals.

The ED 110 includes at least one memory 208. The memory 208 stores instructions and data used, generated, or collected by the ED 110. For example, the memory 208 could store software instructions or modules configured to implement some or all of the functionality and/or embodiments described herein and that are executed by the processing unit(s) 210. Each memory 208 includes any suitable volatile and/or non-volatile storage and retrieval device(s). Any suitable type of memory may be used, such as random access memory (RAM), read only memory (ROM), hard disk, optical disc, subscriber identity module (SIM) card, memory stick, secure digital (SD) memory card, on-processor cache, and the like.

The ED 110 may further include one or more input/output devices (not shown) or interfaces (such as a wired interface to the internet 150 in FIG. 1). The input/output devices permit interaction with a user or other devices in the network. Each input/output device includes any suitable structure for providing information to or receiving information from a user, such as a speaker, microphone, keypad, keyboard, display, or touch screen, including network interface communications.

The ED 110 further includes a processor 210 for performing operations including those related to preparing a transmission for uplink transmission to the NT-TRP 172 and/or T-TRP 170, those related to processing downlink transmissions received from the NT-TRP 172 and/or T-TRP 170, and those related to processing sidelink transmission to and from another ED 110. Processing operations related to preparing a transmission for uplink transmission may include operations such as encoding, modulating, transmit beamforming, and generating symbols for transmission. Processing operations related to processing downlink transmissions may include operations such as receive beamforming, demodulating and decoding received symbols. Depending upon the embodiment, a downlink transmission may be received by the receiver 203, possibly using receive beamforming, and the processor 210 may extract signaling from the downlink transmission (e.g. by detecting and/or decoding the signaling). An example of signaling may be a reference signal transmitted by NT-TRP 172 and/or T-TRP 170. In some embodiments, the processor 276 implements the transmit beamforming and/or receive beamforming based on the indication of beam direction, e.g. beam angle information (BAI), received from T-TRP 170. In some embodiments, the processor 210 may perform operations relating to network access (e.g. initial access) and/or downlink synchronization, such as operations relating to detecting a synchronization sequence, decoding and obtaining the system information, etc. In some embodiments, the processor 210 may perform channel estimation, e.g. using a reference signal received from the NT-TRP 172 and/or T-TRP 170.

Although not illustrated, the processor 210 may form part of the transmitter 201 and/or receiver 203. Although not illustrated, the memory 208 may form part of the processor 210.

The processor 210, and the processing components of the transmitter 201 and receiver 203 may each be implemented by the same or different one or more processors that are configured to execute instructions stored in a memory (e.g. in memory 208). Alternatively, some or all of the processor 210, and the processing components of the transmitter 201 and receiver 203 may be implemented using dedicated circuitry, such as a programmed field-programmable gate array (FPGA), a graphical processing unit (GPU), or an application-specific integrated circuit (ASIC).

The T-TRP 170 may be known by other names in some implementations, such as a base station, a base transceiver station (BTS), a radio base station, a network node, a network device, a device on the network side, a transmit/receive node, a Node B, an evolved NodeB (eNodeB or eNB), a Home eNodeB, a next Generation NodeB (gNB), a transmission point (TP)), a site controller, an access point (AP), or a wireless router, a relay station, a remote radio head, a terrestrial node, a terrestrial network device, or a terrestrial base station, base band unit (BBU), remote radio unit (RRU), active antenna unit (AAU), remote radio head (RRH), central unit (CU), distribute unit (DU), positioning node, among other possibilities. The T-TRP 170 may be macro BSs, pico BSs, relay node, donor node, or the like, or combinations thereof. The T-TRP 170 may refer to the forging devices or apparatus (e.g. communication module, modem, or chip) in the forgoing devices.

In some embodiments, the parts of the T-TRP 170 may be distributed. For example, some of the modules of the T-TRP 170 may be located remote from the equipment housing the antennas of the T-TRP 170, and may be coupled to the equipment housing the antennas over a communication link (not shown) sometimes known as front haul, such as common public radio interface (CPRI). Therefore, in some embodiments, the term T-TRP 170 may also refer to modules on the network side that perform processing operations, such as determining the location of the ED 110, resource allocation (scheduling), message generation, and encoding/decoding, and that are not necessarily part of the equipment housing the antennas of the T-TRP 170. The modules may also be coupled to other T-TRPs. In some embodiments, the T-TRP 170 may actually be a plurality of T-TRPs that are operating together to serve the ED 110, e.g. through coordinated multipoint transmissions.

The T-TRP 170 includes at least one transmitter 252 and at least one receiver 254 coupled to one or more antennas 256. Only one antenna 256 is illustrated. One, some, or all of the antennas may alternatively be panels. The transmitter 252 and the receiver 254 may be integrated as a transceiver. The T-TRP 170 further includes a processor 260 for performing operations including those related to: preparing a transmission for downlink transmission to the ED 110, processing an uplink transmission received from the ED 110, preparing a transmission for backhaul transmission to NT-TRP 172, and processing a transmission received over backhaul from the NT-TRP 172. Processing operations related to preparing a transmission for downlink or backhaul transmission may include operations such as encoding, modulating, precoding (e.g. MIMO precoding), transmit beamforming, and generating symbols for transmission. Processing operations related to processing received transmissions in the uplink or over backhaul may include operations such as receive beamforming, and demodulating and decoding received symbols. The processor 260 may also perform operations relating to network access (e.g. initial access) and/or downlink synchronization, such as generating the content of synchronization signal blocks (SSBs), generating the system information, etc. In some embodiments, the processor 260 also generates the indication of beam direction, e.g. BAI, which may be scheduled for transmission by scheduler 253. The processor 260 performs other network-side processing operations described herein, such as determining the location of the ED 110, determining where to deploy NT-TRP 172, etc. In some embodiments, the processor 260 may generate signaling, e.g. to configure one or more parameters of the ED 110 and/or one or more parameters of the NT-TRP 172. Any signaling generated by the processor 260 is sent by the transmitter 252. Note that “signaling”, as used herein, may alternatively be called control signaling. Dynamic signaling may be transmitted in a control channel, e.g. a physical downlink control channel (PDCCH), and static or semi-static higher layer signaling may be included in a packet transmitted in a data channel, e.g. in a physical downlink shared channel (PDSCH).

A scheduler 253 may be coupled to the processor 260. The scheduler 253 may be included within or operated separately from the T-TRP 170, which may schedule uplink, downlink, and/or backhaul transmissions, including issuing scheduling grants and/or configuring scheduling-free (“configured grant”) resources. The T-TRP 170 further includes a memory 258 for storing information and data. The memory 258 stores instructions and data used, generated, or collected by the T-TRP 170. For example, the memory 258 could store software instructions or modules configured to implement some or all of the functionality and/or embodiments described herein and that are executed by the processor 260.

Although not illustrated, the processor 260 may form part of the transmitter 252 and/or receiver 254. Also, although not illustrated, the processor 260 may implement the scheduler 253. Although not illustrated, the memory 258 may form part of the processor 260.

The processor 260, the scheduler 253, and the processing components of the transmitter 252 and receiver 254 may each be implemented by the same or different one or more processors that are configured to execute instructions stored in a memory, e.g. in memory 258. Alternatively, some or all of the processor 260, the scheduler 253, and the processing components of the transmitter 252 and receiver 254 may be implemented using dedicated circuitry, such as a FPGA, a GPU, or an ASIC.

Although the NT-TRP 172 is illustrated as a drone only as an example, the NT-TRP 172 may be implemented in any suitable non-terrestrial form. Also, the NT-TRP 172 may be known by other names in some implementations, such as a non-terrestrial node, a non-terrestrial network device, or a non-terrestrial base station. The NT-TRP 172 includes a transmitter 272 and a receiver 274 coupled to one or more antennas 280. Only one antenna 280 is illustrated. One, some, or all of the antennas may alternatively be panels. The transmitter 272 and the receiver 274 may be integrated as a transceiver. The NT-TRP 172 further includes a processor 276 for performing operations including those related to: preparing a transmission for downlink transmission to the ED 110, processing an uplink transmission received from the ED 110, preparing a transmission for backhaul transmission to T-TRP 170, and processing a transmission received over backhaul from the T-TRP 170. Processing operations related to preparing a transmission for downlink or backhaul transmission may include operations such as encoding, modulating, precoding (e.g. MIMO precoding), transmit beamforming, and generating symbols for transmission. Processing operations related to processing received transmissions in the uplink or over backhaul may include operations such as receive beamforming, and demodulating and decoding received symbols. In some embodiments, the processor 276 implements the transmit beamforming and/or receive beamforming based on beam direction information (e.g. BAI) received from T-TRP 170. In some embodiments, the processor 276 may generate signaling, e.g. to configure one or more parameters of the ED 110. In some embodiments, the NT-TRP 172 implements physical layer processing, but does not implement higher layer functions such as functions at the medium access control (MAC) or radio link control (RLC) layer. As this is only an example, more generally, the NT-TRP 172 may implement higher layer functions in addition to physical layer processing.

The NT-TRP 172 further includes a memory 278 for storing information and data. Although not illustrated, the processor 276 may form part of the transmitter 272 and/or receiver 274. Although not illustrated, the memory 278 may form part of the processor 276.

The processor 276 and the processing components of the transmitter 272 and receiver 274 may each be implemented by the same or different one or more processors that are configured to execute instructions stored in a memory, e.g. in memory 278. Alternatively, some or all of the processor 276 and the processing components of the transmitter 272 and receiver 274 may be implemented using dedicated circuitry, such as a programmed FPGA, a GPU, or an ASIC. In some embodiments, the NT-TRP 172 may actually be a plurality of NT-TRPs that are operating together to serve the ED 110, e.g. through coordinated multipoint transmissions.

The T-TRP 170, the NT-TRP 172, and/or the ED 110 may include other components, but these have been omitted for the sake of clarity.

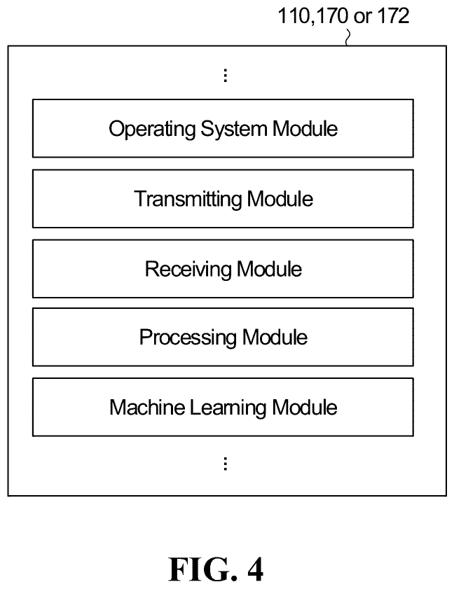

One or more steps of the embodiment methods provided herein may be performed by corresponding units or modules, according to FIG. 4. FIG. 4 illustrates units or modules in a device, such as in ED 110, in T-TRP 170, or in NT-TRP 172. For example, a signal may be transmitted by a transmitting unit or a transmitting module. For example, a signal may be transmitted by a transmitting unit or a transmitting module. A signal may be received by a receiving unit or a receiving module. A signal may be processed by a processing unit or a processing module. Other steps may be performed by an artificial intelligence (AI) or machine learning (ML) module. The respective units or modules may be implemented using hardware, one or more components or devices that execute software, or a combination thereof. For instance, one or more of the units or modules may be an integrated circuit, such as a programmed FPGA, a GPU, or an ASIC. It will be appreciated that where the modules are implemented using software for execution by a processor for example, they may be retrieved by a processor, in whole or part as needed, individually or together for processing, in single or multiple instances, and that the modules themselves may include instructions for further deployment and instantiation.

Additional details regarding the EDs 110, T-TRP 170, and NT-TRP 172 are known to those of skill in the art. As such, these details are omitted here.

### Generation of Synchronization Sequences for CFO Estimation

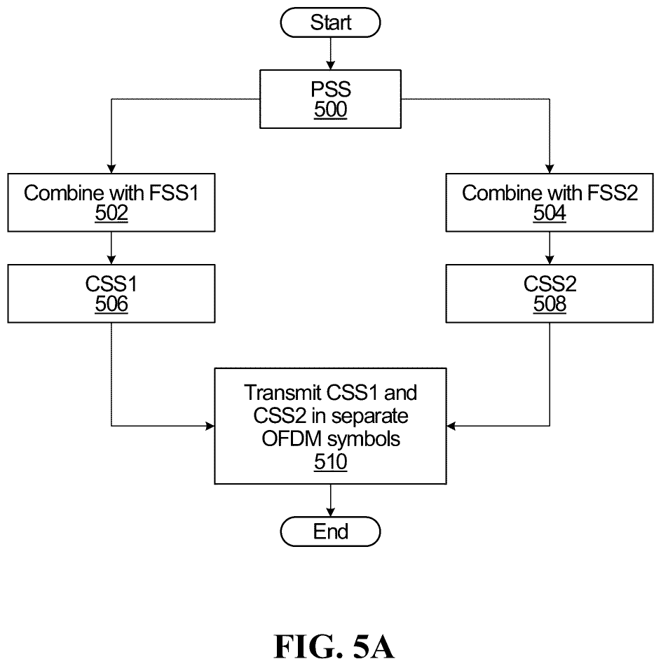

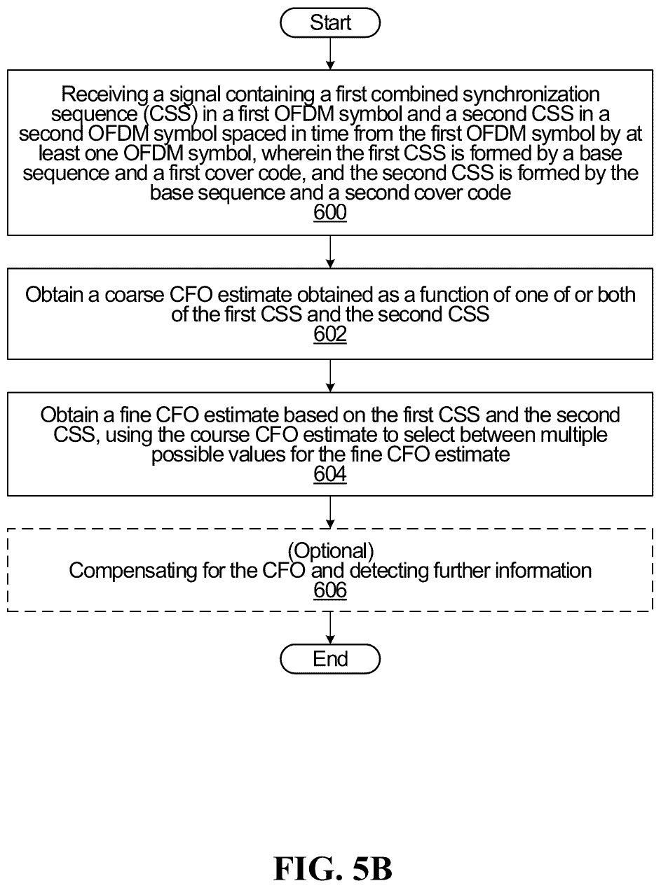

FIG. 5A is a block diagram of a method of generating and transmitting two sequences for use in CFO estimation provided by an embodiment of the disclosure. FIG. 5B is a flowchart corresponding method of CFO estimation provided by an embodiment of the disclosure. The method of FIG. 5A may be performed by any transmitter that makes a transmission, for which CFO estimation is to take place. In a specific example, any device that performs transmission in FIG. 1, or a TRP such as one of those depicted in FIG. 2 or 3 is configured to implement this method, for example through the inclusion of appropriate computer executable instructions in memory.

The method of FIG. 5B may be performed by any receiver that makes a reception, for which CFO estimation is to take place. In a specific example, any device that performs reception in FIG. 1, or an ED such as one or those depicted in FIG. 2 or 3 is configured to implement this method, for example through the inclusion of appropriate computer executable instructions in memory.

Referring first to FIG. 5A, the method starts at 500 with obtaining a secondary synchronization sequence (SSS) or PSS. For the purpose of the explanation that follows, it is assumed that the PSS is used as indicated at 500. More generally, any base sequence can be used.

At 502, the PSS is combined with a first cover code referred to herein as frequency synchronization sequence 1 (FSS₁) to produce a first combined synchronization sequence CSS₁ 506, and at 504, the PSS is combined with a second cover code referred to herein as frequency synchronization sequence 2 (FSS₂) to produce a second combined synchronization sequence CSS₂ 508. The two sequences CSS₁ and CSS₂ use the same base sequence (PSS) and are produced using the same or different cover codes.

a. At 510, the two synchronization sequences CSS₁ and CSS₂ are transmitted in two separate OFDM symbols. The two separate OFDM symbols may be consecutive, or there may be a gap of one or more OFDM symbols between the two OFDM symbols

By virtue of the fact that a pair of combined synchronization sequences CSS₁, CSS₂ is based on the same base sequence (PSS in this example), each combined synchronization sequence carries any information carried by the base sequence, for example, cell ID. The combined synchronization sequences can also help with phase tracking during initial access.

In a special case to allow for backwards compatibility, one of the cover codes for the PSS (e.g. FSS₁) can be an all ones sequence, which is the equivalent of no cover code.

Referring now to FIG. 5B, shown is a flowchart of a method of CFO estimation provided by an embodiment of the disclosure. The method is based on processing the CSS₁ and CSS₂ transmitted based on the method of FIG. 5A. The method begins at 600 with receiving a signal containing a first combined synchronization sequence (CSS) in a first OFDM symbol and a second CSS in a second OFDM symbol. The first CSS is formed by a base sequence and a first cover code, and the second CSS is formed by the base sequence and a second cover code. At 602, a coarse CFO estimate is obtained as a function of one combined synchronization sequence or both combined synchronization sequences (e.g. autocorrelation ratio, amplitude square ratio, signal strength, covariance matrix of the received signals (e.g. at different times or different radio frequency chains (RFCs)), . . . ). A coarse estimate is sufficient as long as it provides a CFO accuracy that is of acceptable range for the fine estimation step. A detailed example of coarse estimation is provided below.

At 604, a fine CFO estimate is obtained that is based on both synchronization sequences considering phase difference between corresponding samples from different training symbols (e.g. OFDM symbols carrying CSS₁ and CSS₂). However, due to the ambiguity that results from the two-x wrapping of the phase, the fine CFO estimate may have multiple possible values. The course CFO estimate is used to help select the correct fine CFO estimate from the multiple possible values of the fine CFO estimate. A detailed example of fine CFO estimation is provided below. The coarse estimation helps to reduce the range of the CFO. The fine CFO estimation can be improved depending on the time difference (number of OFDM symbols) between transmission of the two synchronization sequences. In some embodiments, the method includes the further step 606 of compensating for the CFO and detecting further information from the received signal such as information carried by the SSS or PBCH.

While in the above, reference is made to a “coarse CFO estimate” and a “fine CFO estimate”, more generally, first and second estimates are obtained, and the second estimate is more precise than the first estimate.

As detailed above, from the transmitter perspective, the proposed CFO estimation method relies upon the transmission two (or more) combined synchronization sequences CSS that are separate in time. The transmitted CSS are generated using cover codes so as to help improve the CFO estimation accuracy. The covering code or codes (or sequences) is/are used to obtain a primary coarse CFO estimate that is then used as a basis for fine estimation. The cover codes can be designed such that the coarse CFO can be estimated via some functions of these codes. In a specific example, the coarse CFO is estimated based the amplitude square function of the received sequences at the two symbols. For example, the amplitude square of the received samples at each of the two OFDM symbols can be related (e.g. via a ratio function) to help estimate the CFO. A detailed example is provided below. In addition, the combined sequences should be distinguishable from those of other transmitters (or BS) such that the UE can properly detect the PSS (or CSS₁ or 2) for initial access considering the other PSS (or CSS₁ or 2) from other transmitters. For this to be the case, the combined sequences may be selected to have good autocorrelation properties. Good autocorrelation properties may include a correlation that is very high with the same sequence (autocorrelation) and very low with different sequences (cross-correlation).

### Coarse CFO Estimation

One or both of the cover codes are used for coarse estimation of the CFO. They become more useful as they help estimate the CFO with an accuracy level that is sufficient for the fine estimate step. The coarse estimate can be based on the CSS₁ and/or CSS₂ (e.g. autocorrelation ratio, amplitude square ratio, signal strengths, of the code pairs as discussed previously), but alternatively the coarse estimate can be obtained for example using PSS, and/or SSS, and/or PBCH DMRS. More generally, any coarse estimate method is sufficient as long as it provides a CFO accuracy that is sufficient for the fine estimate step. The following are specific examples of methods of course estimation.

One possible example method involves the use of two copies of the PSS that are sent over two different OFDM symbols (i.e., not using cover codes or using cover codes that consists of ones). In this example, the CFO can be coarsely estimated using the angle between first and the second halves of the cross correlation between the received sequence and the PSS, which is sent in one OFDM symbol.

Another example that involves the use of the cover codes are used can be explained as follows. Denote the time-domain samples of the two sequences (FSS₁ and FSS₂ of length N) by dᵣₛₛ₁ and dₑₛₛ₂, respectively and they are given as follows:

$${d}_{FSS 1} = {[ \begin{matrix}{D}_{FSS} , & {D}_{FSS} , {D}_{FSS} , {D}_{FSS}\end{matrix} ]}^{T} , \\ {d}_{FFS 2} = {[ \begin{matrix}{D}_{FSS} , & {D}_{FSS} {e}^{j π} ,\end{matrix} {D}_{FSS} {e}^{j π} , {D}_{FSS} {e}^{j π} ]}^{T} ,$$

$$where {D}_{FSS} = [ 1 , {e}^{j θ} , ... , {e}^{j ( \frac{N}{4} - 1 ) θ} ]$$

Or simply:

$${d}_{FSS 1} = {[ 1 , {e}^{j θ} , ... , {e}^{j ( \frac{N}{4} - 1 ) θ} , 1 , {e}^{j θ} , ... , \\ {e}^{j ( \frac{N}{4} - 1 ) θ} , 1 , {e}^{j θ} , ... , {e}^{j ( \frac{N}{4} - 1 ) θ} , 1 , {e}^{j θ} , ... , {e}^{j ( \frac{N}{4} - 1 ) θ} ]}^{T} ,$$

$${d}_{FSS 2} = {[ 1 , {e}^{j θ} , ... , {e}^{j ( \frac{N}{4} - 1 ) θ} , {e}^{j π} , {e}^{j ( θ + π )} , ... , \\ {e}^{j ( ( \frac{N}{4} - 1 ) θ + π )} , {e}^{j π} , {e}^{j ( θ + π )} , ... , {e}^{j ( ( \frac{N}{4} - 1 ) θ + π )} , {e}^{j π} , {e}^{j ( θ + π )} , ... , {e}^{j ( ( \frac{N}{4} - 1 ) θ + π )} ]}^{T} ,$$

Note that without loss of generality, it is assumed in this example that N/4 is an integer. Moreover, (.)^{T} denotes the transpose and 0 is in radians and can be selected to result in combined sequences (CSS₁ and CSS₂, obtained by combining FSS₁ and FSS₂ with PSS) that have good autocorrelation properties, i.e., FSS₁ and FSS₂ can be changed for different PSSs such that different CSS₁ and CSS₂ obtained for different PSSs have low correlation.

Then, as explained above, FSS₁ and FSS₂ are combined (multiplication in time or convolution, such as circular convolution, in frequency) with the PSS to get CSS₁ and CSS₂, which are transmitted on two OFDM symbols.

After that, a coarse CFO estimate can be obtained from the ratio of the amplitude square of the received sequences of two OFDM symbols (denote r₁(i) (resp. r₂(i)) for i∈{0,1, . . . , N−1} as the received ith time domain sample of CSS₁ (resp. CSS₂) and let y₁=Eᵢ₌₀^{N-1}r₁ (i) and y₂=Eᵢ₌₀^{N-1}r₂(i)). Specifically, denote e is the CFO normalized to the subcarrier spacing (SCS). Then, considering the amplitude square ratio, e can be obtained from functions satisfying the following formulas:

$${tan}^{2} 0.5 ϑ = \frac{{y}_{2} {y}_{2}^{*}}{{y}_{1} {y}_{1}^{*}} , ϑ = 2 π \times 0.25 \times ϵ$$

Where y*₁(resp. y*₂) denotes the conjugate transpose of y₁ (resp. y₂). Note that with this example (considering both tan² 0.50 and also phase difference between y₁ and y₂), there is no ambiguity of CFO estimation if −0.5π<0.59<0.5π, i.e. −2<∈<2 where ∈ can be estimated as

$$ϵ = \frac{ϑ}{0.5 π} .$$

However, it E is expected to be outside this range, the design of the cover codes can be updated. Nevertheless, the CFO range can be expected for different channel settings (e.g. outdoor, indoor scenario, or small cells, . . . ) and considering the high frequency band, LO accuracy and some offline measurements for Doppler effect and phase errors. This information may help design proper codes and their proper allocation (OFDM symbol locations) for CFO estimation. Note further that the coarse estimation process can be carried after multiplying each ith time domain received sample with the conjugate of the corresponding ith base sequence sample.

### Fine CFO Estimation

A specific example of fine CFO estimation will now be described. Note that based on the transmission of CSS₁ and CSS₂ in separate times (different OFDM symbols where for example CSS₁ is sent in OFDM symbol k and CSS₂ is sent in OFDM symbol h where h>k and both k and h are nonnegative integers (each CSS is sent via the subcarriers (or tones) of a respective OFDM symbol)), a fine CFO estimate can be obtained at the receiver. Specifically, without the noise and fading, after cross correlating the received CSS₁ with FSS₁ and the received CSS₂ with FSS₂, two copies of the received base sequence (e.g. PSS) are obtained but with a phase difference where the ith time domain sample (\hat{r}(i,k)) of the first received sequence (after cross correlating with FSS₁ or multiplying with d*ᵣₛₛ₁ (\hat{r}(i,k)=r (i,k) d*ᵣₛₛ₁ (i)) where d*ᵣₛₛ₁ (i) is the conjugate of the ith element in dᵣₛₛ₁) in OFDM symbol k is related to the ith time domain sample (\hat{r}(i,h)) of the second received sequence (after cross correlating with FSS₂ or multiplying with d*ᵣₛₛ₂ (\hat{r}(i,h)=r (i,h)d*ᵣₛₛ₂ (i)) where d*ᵣₛₛ₂ (i) is the conjugate of the ith element in dᵣₛₛ₂) in OFDM symbol h as follows:

$$\hat{r} ( i , h ) = \hat{r} ( i , k ) {e}^{j 2 π ( h - k ) ϵ}$$

where E is the CFO normalized to the subcarrier spacing (SCS). The formula shows that the received samples at different OFDM symbols are related by the CFO.

From the equation above, it can be seen that the phase difference between the two samples is related to the CFO as follows:
phase difference (a)=2π(h−k)∈+2πL, where e is the normalized CFO, and Lis an integer representing the phase wrapping ambiguity.

Hence, by finding the phase difference, the normalized CFO is also known, but as shown above the phase difference includes an integer multiples of 2x, meaning that the same phase difference can be mapped to multiple CFO (epsilon) values. The normalized CFO can be obtained from the phase difference using any suitable method, based on the above equation, based on a plot, multiple solutions of the equation, or from a look-up table. The coarse estimate is used to choose the most correct value.

The phase difference, for example, can be obtained by cross correlating the received sequences in with FSS₁ and FSS₂. The result is two copies (e.g. N samples represented as \hat{r}(i,h) and \hat{r}(i,k) for i∈{0,1, . . . , N−1}) of the received base sequence but with the phase difference expressed in the equation above (i.e., \hat{r}(i,h)=\hat{r}(i,k) e^{j2π(h-k)∈}). The phase difference can be obtained from these copies in several ways. For example, denote R(h,k) as a function which can be expressed as follows:

$$R ( h , k ) = {\sum }_{i = 0}^{N - 1} \hat{r} ( i , h ) {\hat{r}}^{*} ( i , k )$$

The Phase Difference (a) can be Estimated from the Angle of R(h,k), i.e

$$α = {tan}^{- 1} ( \frac{Imaginary part of R ( h , k )}{Real part of R ( h , k )} )$$

and considering the values of the real and imaginary parts (e.g. o, positive or negative). From a, the CFO can be obtained from the above formula.

Considering some noise sources like fading and additive white Gaussian noise (AWGN), the CFO can be estimated with some error. Note the mean square error (MSE) of the fine CFO estimate decreases with an increase in time difference between the transmission of CSS₁ and CSS₂, whereas the range is reduced with an increase in time difference, as shown in Table 1 below, where a time difference of 1 means the symbols are consecutive.

TABLE 1
Improvement of MSE accuracy and reduction of the estimation range
depending on the time difference (e.g. number of OFDM symbols)
between the synchronization sequences (SS).

| Time difference in terms of OFDM symbols, | | | |
|---|---|---|---|
| i.e. (h-k), between CSS₁ (sent in OFDM | | | |
| symbol # k) and CSS₂ (sent in OFDM | | | |
| symbol # h) where h > k. | MSE | Range | |
| 1 | MSE | 0.5 | SCS |
| 2 | $\frac{MSE 1}{4}$ | 0.25 | SCS |
| n | $\frac{MSE 1}{{n}^{2}}$ | $\frac{1}{2 n}$ | SCS |

### SSB Block Transmission and Reception

Examples of SSB block transmission and reception will now be described. In this example, the base station sends one or more SSB blocks (SSB burst) at one or more directions. More specifically, in some embodiments with multiple antennas at the BS (MIMO systems, antenna arrays), transmitted energy can be focused on a specific direction (beamforming). Then, the BS can send different SSBs in different directions. These can be transmitted at specific frequencies. These frequencies may be, for example, from a predefined/preconfigured frequency raster for the initial access scenario, or the frequencies can be provided to the UE in a non-initial access scenario. The SSB blocks include CSS₁ and CSS₂ as detailed above.

The UE (while beam sweeping) performs autocorrelation of the received signal to determine the presence of the SSB. Note that CSS₁ and CSS₂ have good autocorrelation properties. Note further that the UE can also perform cross correlation with its CSS₁ (and/or CSS₂) sequence.

If the UE knows the cover codes (i.e., FSS₁ and FSS₂), it can still detect the cell ID, even if the PSS is cover coded (by using either/both CSS₁ and CSS₂). The detection can be carried via autocorrelation function or cross correlation with (CSS₁ and/or CSS₂). Also, the UE can easily distinguish between the pair of sequences (CSS₂ and CSS₂) by their cover codes (FSS₁ and FSS₂). After detection, the UE can estimate the CFO using the method described above. After detecting the PSS and estimating CFO, the UE can compensate for the effect of the CFO and then go on with further information detection, for example, detection of information carried on the SSS, and/or detection of physical broadcast channel (PBCH) information.

In some embodiments, for initial access, the SS sequences for CFO estimation like FSS₁ and FSS₂ parameters (in addition to some cell ID information (e.g. PSS)) can be standardized. For example, considering some minimum performance requirements for a high frequency channel (e.g. SNR threshold, PCID detection probability), the SS (CSS₁ and CSS₂) are designed and standardized.

In some embodiments, for non-initial access, the SS sequences for CFO estimation are standardized; in other embodiments they are signalled and in further embodiments a combination of standardization and signalling is used. In a specific example, the base station transmits, using an existing link (e.g. can be in a lower frequency channel), some signalling information to the UE about a transmission at higher frequency that allows the UE to know the synchronization sequences. For example, by using some sensing information (e.g., UE location), the BS (or network) can have some knowledge about the UE channel quality and design/select the SS according to that and inform the UE about such design/selection (e.g. some parameters of FSS₁ and FSS₂). The design/selection of SS (e.g FSS₁ and FSS₂) can be sent to the UE using the existing link (e.g. can be in a lower frequency channel) and/or via RRC signaling to inform the UE about FSS₁ and FSS₂ design. In a first option, the UE is informed of the complete sequences (i.e. send FSS₁ and FSS₂). In a second option, the UE is sent parameters that help the UE generate FSS₁ and FSS₂. In a specific example, such parameters can be 0 and N, where the sequences are specified by the equations used in the specific example for coarse CFO estimation presented above. The parameters can also pertain to the generation of pseudo random sequences like the root and the cyclic shift needed to generate a Zadoff-Chu (ZC) sequence (when used for PSS, FSS₁ or FSS₂), or the polynomial function needed to generate the m-sequences (when used for PSS, FSS₁ or FSS₂). In a third option, FSS₁ and FSS₂ are written in a standard and hence known and used by the UE.

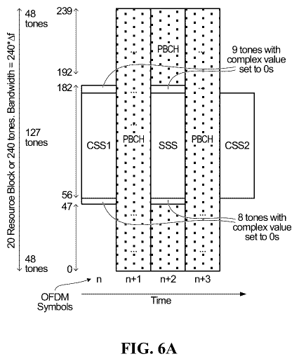

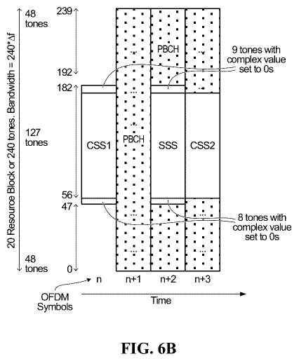

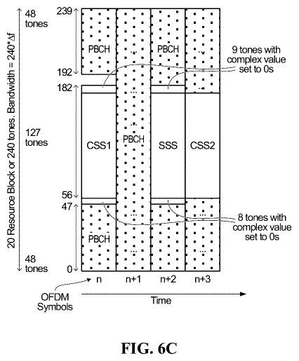

FIGS. 6A, 6B and 6C show three examples of how the sequence pairs (CSS₁, CSS₂) can be allocated in the SSB block. Note that as mentioned earlier, it is assumed that the base sequence is the PSS; however, a different base sequence such as the SSS or even a separate sequence besides SSS and PSS can be used. In FIGS. 6A, 6B, and 6C, time, in units of OFDM symbols, is on the horizontal axis, and frequency, in units of OFDM subcarriers or resource blocks, is on the vertical axis. It should be understood that the symbol locations for the various contents depicted in FIGS. 6A, 6B and 6C can be modified as can the frequency locations for the various of contents.

Referring first to FIG. 6A, compared to the existing SSB block allocation for NR, CSS₁ is transmitted in a first OFDM symbol instead of the PSS. The second, third and fourth OFDM symbols (n+1, n+2, n+3) contain PBCH, DMRS, and SSS consistent with SSB allocation for NR. The CSS₂ is transmitted in a fifth OFDM symbol that is not present in the SSB block allocation for NR. Despite the added symbol for CSS₂, this allocation has backward compatibility with NR standard especially when CSS₁ is identical to PSS, which can be achieved by setting FSS₁ to all ones. Note that by adding one more symbol, more time is needed to send the same SSB burst. However, by increasing the SCS at high frequency, the symbol duration becomes shorter and hence more time becomes available to send more SSB blocks or add more symbols.

Referring first to FIG. 6B, compared to the existing SSB block allocation for NR, CSS₁ is transmitted in a first (nth) OFDM symbol instead of the PSS, and CSS₂ is sent in the fourth symbol (or in the second or third symbol). With this allocation, the fine estimation step for CFO can be less accurate than that which would be achieved with the allocation in FIG. 6A because of the shorter time difference between CSS₁ and CSS₂. However, this reduced accuracy may still be sufficient for some applications (e.g. may have less SNR due to the reduced accuracy but such SNR is acceptable (satisfies a threshold) for specific applications.

With the example of FIG. 6B, CSS₂ is allocated in a resource that would otherwise have been used for a portion of the PBCH payload. In some embodiments the omitted portion of the PBCH payload is transmitted using another method.

In one example, in non-initial access, some PBCH information can be sent by the BS or the network via a lower frequency band (i.e. frequency resources outside those shown in the example of FIG. 6B).

PBCH payload may include a management information block (MIB) that contains information required for a UE to connect to the cell by letting the UE know how to access SIB₁. The MIB payload consists of information regarding the timing of the SBB such as 1) system frame number (SFN) and the 2) half-frame bit. Some other timing information is included in SIB₁ such as SSB position in the burst. Some other parts of the payload of the MIB and SIB₁ are not related to timing and are referred to herein as non-timing information.

In some embodiments, the PBCH information relating to timing is included in the available PBCH resources, i.e. the resources labelled PBCH data in the example of FIG. 6B, and PBCH information that is non-timing information is transmitted using another method, for example, using another lower frequency band available for transmission between the BS and the UE. Note that although the half-frame bit is related to the timing information, it simply indicates the first 5 ms or the second 5 ms of a radio frame is being used to send to the SSB burst. Hence, it can still be informed to the UE using the alternative method.

When the coarse timing of the existing and new links in non-initial access is the same, all the contents of MIB may be excluded from the SSB and the UE can skip decoding the contents of PBCH (i.e. the MIB and/or SIB₁). If the timing is not the same, the new PBCH may contain only the information related to timing while eliminating the non-timing information as they could be communicated to the UE through the existing link. Generally, the existing link refers to the link that is already established between a UE and the network while the new link refers to the link to be established between the UE and the network. Examples of specific scenarios can be explained as follows. One scenario can be the handover scenario where the UE is moving from BS₁ to connect with BS₂. The existing link can refer the UE link with BS₁ while the new link can refer to link with BS₂. Another scenario may refer to the case when the UE is changing its connection with a network from one band to another band, e.g. the UE changes its connection (or existing link) from a lower frequency band (below 6 GHz)) to a new link at higher frequency band like mmWave or sub-THz bands. A third scenario may refer to the case when the UE is changing its connection between two networks, e.g. from LTE to 5G networks where the already connected LTE link may refer to the existing link while the 5G link (to be established) may refer to the new link. One further scenario refers to case when UE is already connected to a primary cell (i.e., can be referred to an existing link) and need to establish a new connection to a secondary cell (i.e., can be referred to an existing link), which can occur in dual-connection and carrier aggregation schemes.

In another example, for initial access, some or all of this portion of the PBCH payload can be allocated in the first symbol (that includes PSS (or CSS₁) only) as shown in the example of FIG. 6C. If the remaining resources are not sufficient for this PBCH portion, the remaining PBCH information can be included in other ways (e.g. by circularly shifting the CSS₂ sequence).

An overall method of CFO estimation, based on the SSB format of FIG. 6A will now be described. A similar process can be defined for other SSB formats.

A1) Obtain Coarse Estimate:
i. The UE can perform autocorrelation of the received signal to determine the presence of the SSB.
ii. Then, based on the timing of SSB presence, the UE can perform cross correlation with CSS₁ in the first symbol and/or CSS₂ in the fifth symbol.
iii. Such cross correlation can help determine a part of the physical cell identifier (PCID) associated with PSS. In LTE and NR (5G), the PCID is obtained from the PSS and SSS. In NR, there are 1008 IDs that are arranged into 336 different groups. Each group is identified by the cell ID group (detected from SSS), and consists of three different sectors, which are identified by the cell ID sector (detected from PSS). Therefore, as there are 3 PSSs, by cross correlating the received signal with the 3 PSS and determining the PSS that leads to the highest SNR, part of the PCID, e.g. cell ID sector, can be determined. Then, from the SSS, the other PCID part can be determined.
iv. Note that for example as there are 3 different sequence for PSS, the corresponding CSS₁ and CSS₂ for each PSS are also different. Note that for example in the current standards (LTE and NR) as discussed above, there are 3 different PSSs. Hence, the FSS₁, FSS₂ and hence CSS₁ and CSS₂ for each PSS can be different.
V. The received sequences in symbols n and n+4 (1 and 5) are correlated with PSS to get FSS₁ and FSS₂. Such sequences can help perform coarse CFO estimate as described above.
vi. Last, given the coarse estimation and by cross correlating the received sequences in symbols 1 and 5 with FSS₁ and FSS₂, respectively, PSS is repeated in symbols 1 and 5 but with the phase difference as described in the equation above, which is helpful to perform fine estimation as shown next.

A2) Obtain Fine Estimate:

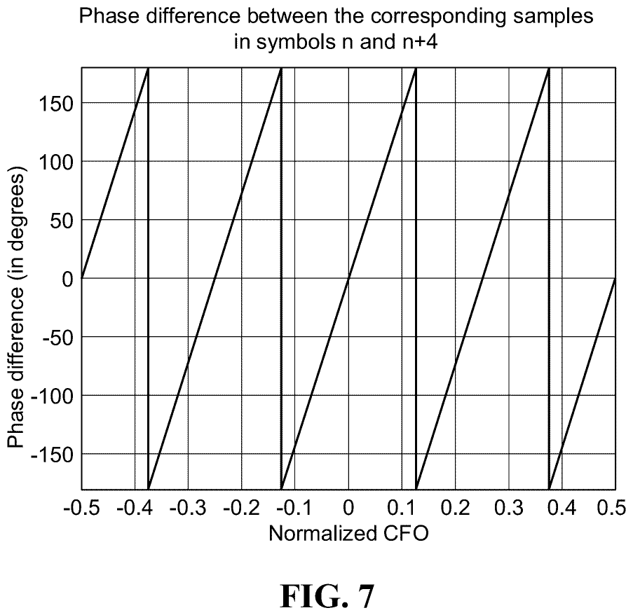

Assume again that there are 3 symbols between CSS₁ and CSS₂ as shown in FIG. 6A. According to the phase relationship presented above, the phase difference (in terms of the normalized CFO to the subcarrier spacing) between the samples in different symbols (OFDM symbols) vs the normalized CFO can be plotted. An example is shown in FIG. 7.
vii. The CFO can be obtained from the estimated phase difference between the received sequences in symbols n and n+4 (1 and 5).
viii. For fine estimation: While increasing the time between the two symbols improves the accuracy (i.e., allows the estimate with a smaller error, smaller MSE), there is ambiguity of the CFO. For example, as shown in FIG. 7, if the phase difference is estimated to be 50 degrees, it is not known if this phase difference corresponds to −0.46, −0.21, 0.03, or 0.28 of CFO (normalized) with an error between +0.01 and −0.01 of the CFO for example.
ix. However, if the coarse estimation determines the CFO is 0.3 (with an error between +0.1 and −0.1 for example, in which case, the range of error is 0.2 (0.2 to 0.4)), it can then be determined that the 50 phase degrees difference in fine estimation corresponds to 0.28 CFO with an error between +0.01 and −0.01.

Numerous modifications and variations of the present disclosure are possible in light of the above teachings. For example, the method can be extended to more than two combined sequences that are sent in more than two symbols such that they can be used for coarse and fine estimation. Moreover, each combined sequence may result from combining more than two sequences. It is also possible to perform the estimation in more than two steps (course and fine). It is therefore to be understood that within the scope of the appended claims, the disclosure may be practiced otherwise than as specifically described herein.

What is claimed is:

1. A method comprising:
obtaining a first combined synchronization sequence based on a base sequence and a first cover code;
obtaining a second combined synchronization sequence based on the base sequence with a second cover code; and
transmitting the first combined synchronization sequence as part of a first orthogonal frequency division multiplexing (OFDM) symbol and transmitting the second combined synchronization sequence as part of a second OFDM symbol.

2. The method of claim 1, wherein obtaining the first combined synchronization sequence based on the base sequence and the first cover code comprising:
combining the base sequence with the first cover code to produce the first combined synchronization sequence.

3. The method of claim 1, wherein obtaining the second combined synchronization sequence based on the base sequence with the second cover code comprising:
combining the base sequence with the second cover code to produce the second combined synchronization sequence.

4. The method of claim 1, wherein the base sequence is one of:
a primary synchronization sequence; and
a secondary synchronization sequence.

5. The method of claim 1, wherein transmitting the first combined synchronization sequence as the part of the first OFDM symbol and transmitting the second combined synchronization sequence as the part of the second OFDM symbol comprises:
transmitting a four OFDM symbol synchronization sequence block (SSB), wherein one of four OFDM symbols in the four OFDM symbol SSB is the first OFDM symbol; and
transmitting a fifth OFDM symbol that is the second OFDM symbol.

6. The method of claim 1, wherein transmitting the first combined synchronization sequence as the part of the first OFDM symbol and transmitting the second combined synchronization sequence as the part of the second OFDM symbol comprises:
transmitting a four OFDM symbol synchronization sequence block (SSB), wherein one of four OFDM symbols in the four OFDM symbol SSB is the first OFDM symbol, and another of the four OFDM symbols is the second OFDM symbol.

7. The method of claim 1, wherein the base sequence is a primary synchronization sequence or a secondary synchronization sequence of a synchronization sequence block.

8. A network element comprising:
at least one processor; and
at least one computer-readable medium having computer executable instructions stored thereon that, when executed by the at least one processor, cause the network element to:
obtain a first combined synchronization sequence based on a base sequence and a first cover code;
obtain a second combined synchronization sequence based on the base sequence with a second cover code; and
transmit the first combined synchronization sequence as part of a first orthogonal frequency division multiplexing (OFDM) symbol and transmitting the second combined synchronization sequence as part of a second OFDM symbol.

9. The network element of claim 8, wherein instructions to obtain the first combined synchronization sequence based on the base sequence and the first cover code comprise instructions to:
combine the base sequence with the first cover code to produce the first combined synchronization sequence.

10. The network element of claim 8, wherein instructions to obtain the second combined synchronization sequence based on the base sequence with the second cover code comprise instructions to:
combine the base sequence with the second cover code to produce the second combined synchronization sequence.

11. The network element of claim 8, wherein the base sequence is one of:
a primary synchronization sequence; or
a secondary synchronization sequence.

12. The network element of claim 8, wherein instructions to transmit the first combined synchronization sequence as the part of the first OFDM symbol and transmit the second combined synchronization sequence as the part of the second OFDM symbol comprises instructions to:
transmit a four OFDM symbol synchronization sequence block (SSB), wherein one of four OFDM symbols in the four OFDM symbol SSB is the first OFDM symbol; and
transmit a fifth OFDM symbol that is the second OFDM symbol.

13. The network element of claim 8, wherein instructions to transmit the first combined synchronization sequence as the part of the first OFDM symbol and transmit the second combined synchronization sequence as the part of the second OFDM symbol comprises instructions to:
transmit a four OFDM symbol synchronization sequence block (SSB), wherein one of four symbols in the four OFDM symbol SSB is the first OFDM symbol, and another of the four OFDM symbols is the second OFDM symbol.

14. The network element of claim 8, wherein the base sequence is a primary synchronization sequence or a secondary synchronization sequence of a synchronization sequence block.

15. A method comprising:
receiving a signal containing a first combined synchronization sequence (CSS) in a first orthogonal frequency division multiplexing (OFDM) symbol and a second CSS in a second OFDM symbol, wherein the first CSS is formed by a base sequence and a first cover code, and the second CSS is formed by the base sequence and a second cover code;
obtaining a first carrier frequency offset (CFO) estimate obtained as a function of one of or both of the first CSS and the second CSS;
obtaining a second CFO estimate based on the first CSS and the second CSS, using a coarse CFO estimate to select between multiple possible values for a fine CFO estimate, wherein the second CFO estimate is more precise than the first CFO estimate; and
compensating for the CFO and detecting further information.

16. The method of claim 15, wherein obtaining the coarse CFO estimate is based on a ratio of amplitude square of received samples for each of the first and second CSS.

17. The method of claim 15, wherein obtaining the fine CFO estimate comprises:
estimating a phase difference between a sample of the first CSS and a sample of the second CSS; and
obtaining the fine CFO estimate from the phase difference.

18. An apparatus comprising:
at least one processor; and
at least one computer-readable medium having computer executable instructions stored thereon that, when executed by the at least one processor, cause the apparatus to:
receive a signal containing a first combined synchronization sequence (CSS) in a first orthogonal frequency division multiplexing (OFDM) symbol and a second CSS in a second OFDM symbol, wherein the first CSS is formed by a base sequence and a first cover code, and the second CSS is formed by the base sequence and a second cover code;
obtain a first carrier frequency offset (CFO) estimate obtained as a function of one of or both of the first CSS and the second CSS;
obtain a second CFO estimate based on the first CSS and the second CSS, using a coarse CFO estimate to select between multiple possible values for a fine CFO estimate, wherein the second CFO estimate is more precise than the first CFO estimate; and
compensate for the CFO and detecting further information.

19. The apparatus of claim 18, wherein obtaining the coarse CPO estimate is based on a ratio of amplitude square of received samples for each of the first CSS and the second CSS.

20. The apparatus of claim 18, wherein obtaining the fine CFO estimate comprises:
estimate a phase difference between of the first CSS and the second CSS; and
obtain the fine CFO estimate from the phase difference.
